(19) United States
(12) Patent Application Publication
(10) Pub. No.: US 2005/0109152 A1
(43) Pub. Date: May 26, 2005

(54) Handlebar adjusting device for bicycle

(76) Inventor: Jung-Yu Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/724,334

(22) Filed: Nov. 25, 2003

(51) Int. Cl. B62K 21/16

(52) U.S. Cl. 74/551.3

(57) ABSTRACT

A handlebar adjusting device includes an upright tube, a support bracket, a telescopic member, a pivot base, and an operation handle. The support bracket is moved by movement of the telescopic member to pivot upward and downward relative to the upright tube, so that the handlebar is moved with the support bracket so as to adjust the position of the handlebar. Thus, the position the handlebar can be adjusted easily and conveniently, thereby facilitating the user adjusting the handlebar.

### BACKGROUND OF THE INVENTION

1. Field of the Invention

The present invention relates to a handlebar adjusting device, and more particularly to a handlebar adjusting device for a bicycle.

2. Description of the Related Art

A conventional handlebar for a bicycle includes a stem rotatably mounted on the frame of the bicycle. Thus, the handlebar is rotatably mounted on the frame of the bicycle to facilitate grip and manipulation of the rider. However, the handlebar is fixed on the bicycle without adjustment, so that the position and angle of the handlebar cannot be adjusted easily, thereby causing inconvenience to the rider.

### SUMMARY OF THE INVENTION

The primary objective of the present invention is to provide a handlebar adjusting device for a bicycle.

Another objective of the present invention is to provide a handlebar adjusting device, wherein the position the handlebar can be adjusted easily and conveniently, thereby facilitating the user adjusting the handlebar.

A further objective of the present invention is to provide a handlebar adjusting device, wherein the support bracket is moved by movement of the telescopic member to pivot upward and downward relative to the upright tube, so that the handlebar is moved with the support bracket so as to adjust the position of the handlebar.

In accordance with the present invention, there is provided a handlebar adjusting device, comprising:
an upright tube having an upper end formed with a protruding head and a protruding pivot block located under the protruding head;
a support bracket pivotally mounted on the upper end of the upright tube and having a first end formed with a bifurcated pivot portion pivotally mounted on the protruding head of the upright tube and a second end formed with two spaced pivot ears;
a telescopic member pivotally mounted on the upper end of the upright tube and having a first end formed with a substantially U-shaped pivot bracket pivotally mounted on the pivot block of the upright tube and a retractable second end provided with a movable press button;
a pivot base having a first end secured on the second end of the telescopic member and a second end pivotally mounted on the two spaced pivot ears of the support bracket; and
an operation handle pivotally mounted between the two spaced pivot ears of the support bracket and having a first side formed with an arcuate urging portion that is rotated with the operation handle to press the press button into the telescopic member and a second side formed with an arcuate recess for receiving the press button of the telescopic member.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a handlebar adjusting device in accordance with the preferred embodiment of the present invention;

FIG. 2 is a perspective assembly view of the handlebar adjusting device in accordance with the preferred embodiment of the present invention;

FIG. 3 is a side plan cross-sectional view of the handlebar adjusting device as shown in FIG. 2;

FIG. 4 is a schematic operational view of the handlebar adjusting device as shown in FIG. 3; and

FIG. 5 is a schematic operational view of the handlebar adjusting device as shown in FIG. 2.

### DETAILED DESCRIPTION OF THE INVENTION

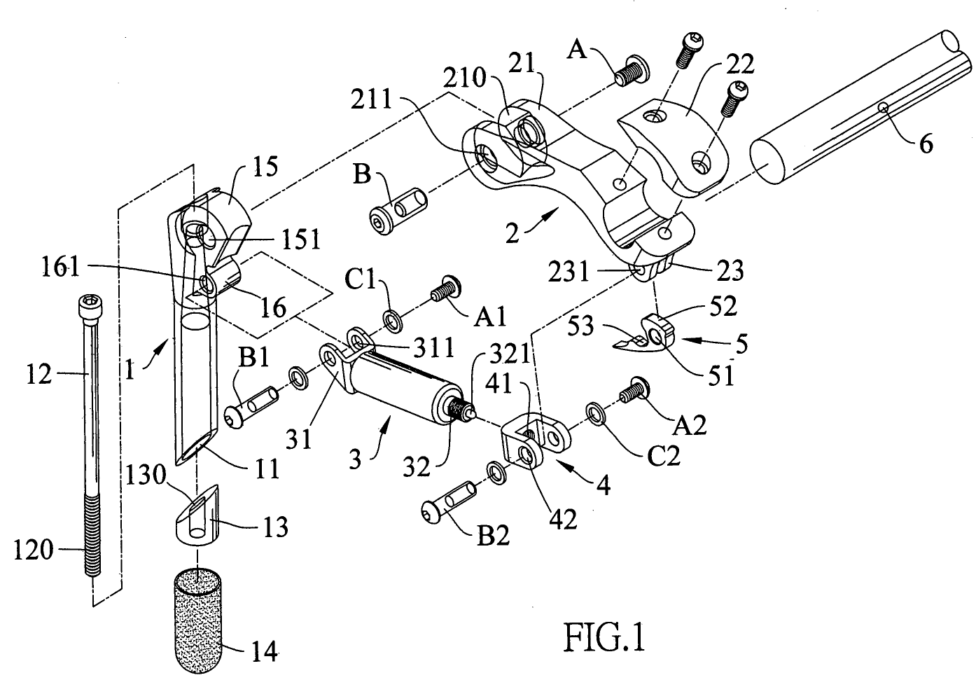

Referring to the drawings and initially to FIGS. 1-3, a handlebar adjusting device for a bicycle in accordance with the preferred embodiment of the present invention comprises an upright tube 1, a support bracket 2, a telescopic member 3, a pivot base 4, and an operation handle 5.

The upright tube 1 is inserted into the head tube (not shown) of the bicycle. The upright tube 1 has an inner wall formed with a receiving chamber 11 for receiving a threaded rod 12 having a distal end protruded outward from a tapered lower end of the upright tube 1 and formed with an outer thread 120. A tapered sleeve 13 is urged on the tapered lower end of the upright tube 1 and is formed with an inner thread 130 screwed on the outer thread 120 of the threaded rod 12. A soft protective jacket 14 is mounted on the tapered sleeve 13. The upright tube 1 has an upper end formed with a protruding head 15 formed with a through hole 151. The protruding head 15 of the upright tube 1 is arc-shaped and has a side extended downward in an oblique manner. The upper end of the upright tube 1 is formed with a protruding pivot block 16 located under the protruding head 15 and formed with a through hole 161.

The support bracket 2 is pivotally mounted on the upper end of the upright tube 1 and has a first end formed with a bifurcated pivot portion 21 pivotally mounted on the protruding head 15 of the upright tube 1 and formed with a pivot hole 211 aligning with the through hole 151 of the protruding head 15 of the upright tube 1. Preferably, the pivot portion 21 of the support bracket 2 is formed with an opening 210 for receiving the protruding head 15 of the upright tube 1.

The handlebar adjusting device further comprises a threaded sleeve B extended through the pivot hole 211 of the pivot portion 21 of the support bracket 2 and the through hole 151 of the protruding head 15 of the upright tube 1, and a screw A screwed into the threaded sleeve B and urged on the pivot portion 21 of the support bracket 2, so that the pivot portion 21 of the support bracket 2 is pivotally mounted on the protruding head 15 of the upright tube 1.

The support bracket 2 has a second end formed with two spaced pivot ears 23 each formed with a through hole 231. An arcuate clamping block 22 is secured on the second end of the support bracket 2, and a handlebar 6 is clamped between the clamping block 22 and the second end of the support bracket 2.

The telescopic member 3 is pivotally mounted on the upper end of the upright tube 1 and has a first end formed with a substantially U-shaped pivot bracket 31 pivotally mounted on the pivot block 16 of the upright tube 1 and formed with a pivot hole 311 aligning with the through hole 161 of the pivot block 16 of the upright tube 1.

The handlebar adjusting device further comprises a threaded sleeve B1 extended through the pivot hole 311 of the pivot bracket 31 of the telescopic member 3 and the through hole 161 of the pivot block 16 of the upright tube 1, two washers C1 mounted on the threaded sleeve B1, and a screw A1 screwed into the threaded sleeve B1 and urged on one of the two washers C1, so that the pivot bracket 31 of the telescopic member 3 is pivotally mounted on the pivot block 16 of the upright tube 1.

The telescopic member 3 has a retractable second end provided with a movable press button 321 and formed with an outer thread 32. Thus, when the press button 321 is pressed into the telescopic member 3, the retractable second end of the telescopic member 3 is movable relative to the telescopic member 3, and when the press button 321 is protruded outward from the telescopic member 3, the retractable second end of the telescopic member 3 is fixed without movement. Preferably, the telescopic member 3 is a hydraulic cylinder, a pneumatic cylinder or a motorized cylinder.

The pivot base 4 is substantially U-shaped and is secured on the second end of the telescopic member 3. The pivot base 4 has a first end formed with an inner thread 41 screwed on the outer thread 32 of the second end of the telescopic member 3 and a second end pivotally mounted on the two spaced pivot ears 23 of the support bracket 2 and formed with a pivot hole 42 aligning with the through hole 231 of each of the two spaced pivot ears 23 of the support bracket 2.

The operation handle 5 is pivotally mounted between the two spaced pivot ears 23 of the support bracket 2 and is formed with a pivot hole 51 aligning with the through hole 231 of each of the two spaced pivot ears 23 of the support bracket 2.

The handlebar adjusting device further comprises a threaded sleeve B2 extended through the pivot hole 42 of the pivot base 4, the through hole 231 of each of the two spaced pivot ears 23 of the support bracket 2 and the pivot hole 51 of the operation handle 5, two washers C2 mounted on the threaded sleeve B2, and a screw A2 screwed into the threaded sleeve B2 and urged on one of the two washers C2, so that the pivot base 4 is pivotally mounted on the two spaced pivot ears 23 of the support bracket 2 and the operation handle 5 is pivotally mounted between the two spaced pivot ears 23 of the support bracket 2.

The operation handle 5 has a first side formed with an arcuate urging portion 52 that is rotated with the operation handle 5 to press the press button 321 into the telescopic member 3 and a second side formed with an arcuate recess 53 for receiving the press button 321 of the telescopic member 3.

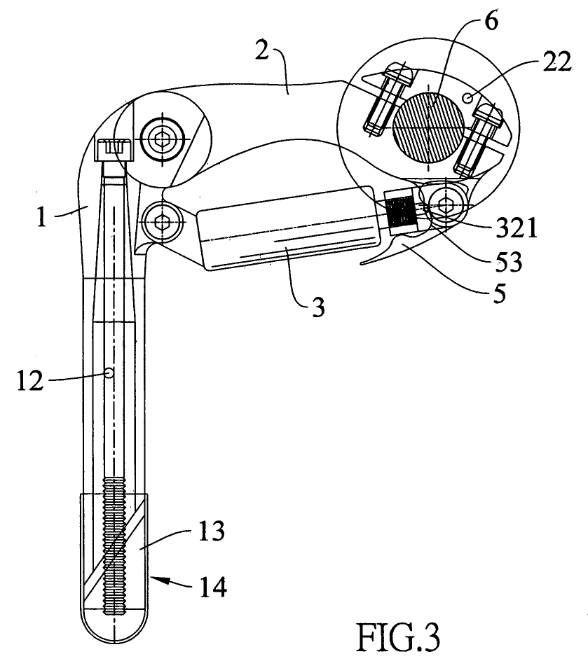

In operation, referring to FIGS. 1-5, the press button 321 of the telescopic member 3 is initially protruded outward from the second end of the telescopic member 3 and received in the arcuate recess 53 of the operation handle 5 as shown in FIG. 3, so that the second end of the telescopic member 3 is fixed without movement.

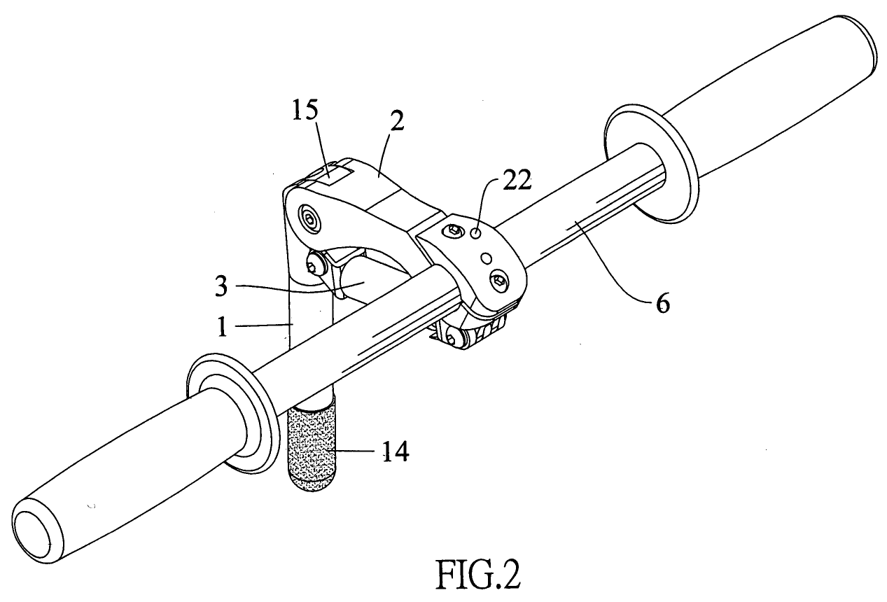

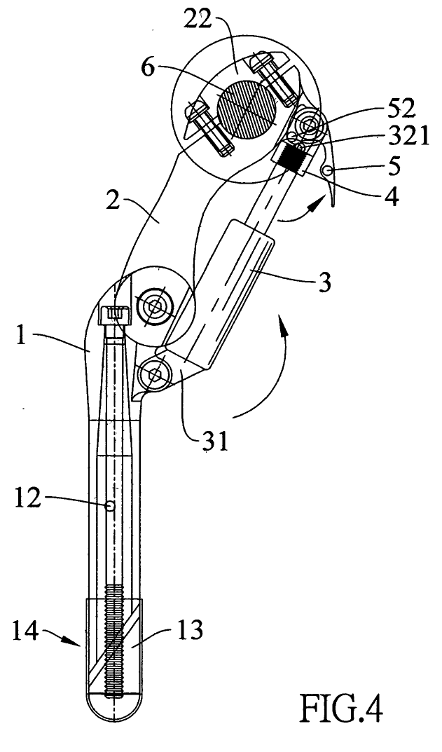

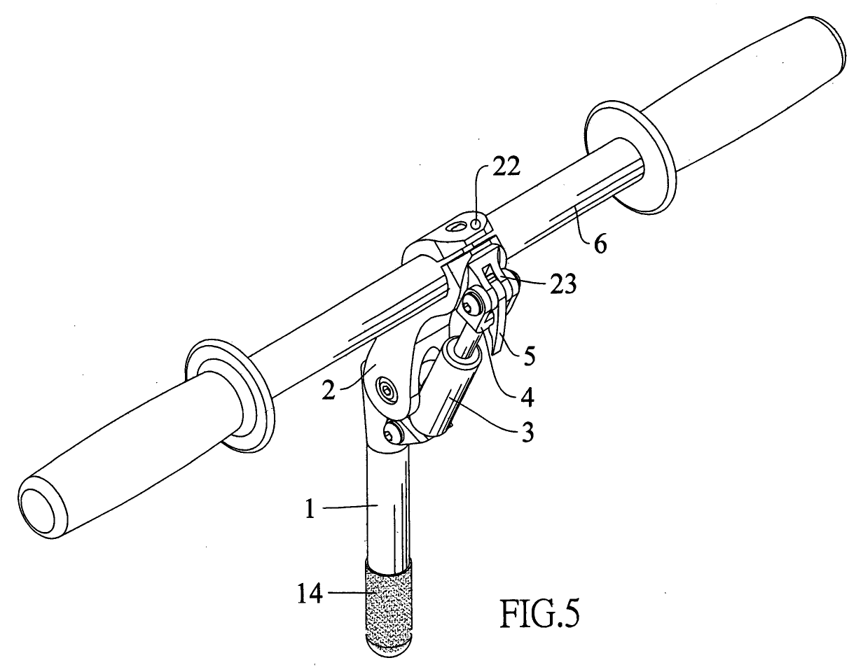

In adjustment, when the operation handle 5 is rotated, the urging portion 52 of the operation handle 5 is rotated to touch and press the press button 321 into the telescopic member 3 as shown in FIG. 4, so that the second end of the telescopic member 3 is movable outward (or inward) relative to the telescopic member 3. Thus, the support bracket 2 is moved by movement of the second end of the telescopic member 3 to pivot upward relative to the upright tube 1, so that the handlebar 6 is moved from the position as shown in FIG. 2 to the position as shown in FIG. 5 so as to adjust the position of the handlebar 6.

Accordingly, the position the handlebar 6 can be adjusted easily and conveniently, thereby facilitating the user adjusting the handlebar 6.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A handlebar adjusting device, comprising:
an upright tube having an upper end formed with a protruding head and a protruding pivot block located under the protruding head;
a support bracket pivotally mounted on the upper end of the upright tube and having a first end formed with a bifurcated pivot portion pivotally mounted on the protruding head of the upright tube and a second end formed with two spaced pivot ears;
a telescopic member pivotally mounted on the upper end of the upright tube and having a first end formed with a substantially U-shaped pivot bracket pivotally mounted on the pivot block of the upright tube and a retractable second end provided with a movable press button;
a pivot base having a first end secured on the second end of the telescopic member and a second end pivotally mounted on the two spaced pivot ears of the support bracket; and
an operation handle pivotally mounted between the two spaced pivot ears of the support bracket and having a first side formed with an arcuate urging portion that is rotated with the operation handle to press the press button into the telescopic member and a second side formed with an arcuate recess for receiving the press button of the telescopic member.

2. The handlebar adjusting device in accordance with claim 1, wherein the upright tube has an inner wall formed with a receiving chamber for receiving a threaded rod having a distal end protruded outward from a tapered lower end of the upright tube and formed with an outer thread, and the handlebar adjusting device further comprises a tapered sleeve urged on the tapered lower end of the upright tube and formed with an inner thread screwed on the outer thread of the threaded rod.

3. The handlebar adjusting device in accordance with claim 2, further comprising a soft protective jacket mounted on the tapered sleeve.

4. The handlebar adjusting device in accordance with claim 1, wherein the protruding head of the upright tube is arc-shaped and has a side extended downward in an oblique manner.

5. The handlebar adjusting device in accordance with claim 1, wherein the pivot portion of the support bracket is formed with an opening for receiving the protruding head of the upright tube.

6. The handlebar adjusting device in accordance with claim 1, wherein the protruding head of the upright tube is formed with a through hole, the pivot portion of the support bracket is formed with a pivot hole aligning with the through hole of the protruding head of the upright tube, and the handlebar adjusting device further comprises a threaded sleeve extended through the pivot hole of the pivot portion of the support bracket and the through hole of the protruding head of the upright tube, and a screw screwed into the threaded sleeve and urged on the pivot portion of the support bracket, so that the pivot portion of the support bracket is pivotally mounted on the protruding head of the upright tube.

7. The handlebar adjusting device in accordance with claim 1, wherein the protruding pivot block of the upright tube is formed with a through hole, the pivot bracket of the telescopic member is formed with a pivot hole aligning with the through hole of the pivot block of the upright tube, and the handlebar adjusting device further comprises a threaded sleeve extended through the pivot hole of the pivot bracket of the telescopic member and the through hole of the pivot block of the upright tube, two washers mounted on the threaded sleeve, and a screw screwed into the threaded sleeve and urged on one of the two washers, so that the pivot bracket of the telescopic member is pivotally mounted on the pivot block of the upright tube.

8. The handlebar adjusting device in accordance with claim 1, wherein the pivot base is substantially U-shaped.

9. The handlebar adjusting device in accordance with claim 1, wherein the retractable second end of the telescopic member is formed with an outer thread, and the first end of the pivot base is formed with an inner thread screwed on the outer thread of the second end of the telescopic member.

10. The handlebar adjusting device in accordance with claim 1, wherein each of the two spaced pivot ears of the support bracket is formed with a through hole, the second end of the pivot base is formed with a pivot hole aligning with the through hole of each of the two spaced pivot ears of the support bracket, the operation handle is formed with a pivot hole aligning with the through hole of each of the two spaced pivot ears of the support bracket, and the handlebar adjusting device further comprises a threaded sleeve extended through the pivot hole of the pivot base, the through hole of each of the two spaced pivot ears of the support bracket and the pivot hole of the operation handle, two washers mounted on the threaded sleeve, and a screw screwed into the threaded sleeve and urged on one of the two washers, so that the pivot base is pivotally mounted on the two spaced pivot ears of the support bracket and the operation handle is pivotally mounted between the two spaced pivot ears of the support bracket.

11. The handlebar adjusting device in accordance with claim 1, wherein the telescopic member is a hydraulic cylinder.

12. The handlebar adjusting device in accordance with claim 1, wherein the telescopic member is a pneumatic cylinder.

13. The handlebar adjusting device in accordance with claim 1, wherein the telescopic member is a motorized cylinder.

14. The handlebar adjusting device in accordance with claim 1, wherein when the press button is pressed into the telescopic member, the retractable second end of the telescopic member is movable relative to the telescopic member.

15. The handlebar adjusting device in accordance with claim 1, wherein when the press button is protruded outward from the telescopic member, the retractable second end of the telescopic member is fixed without movement.
